(19) United States
(12) Patent Application Publication
(10) Pub. No.: US 2012/0304872 A1
(43) Pub. Date: Dec. 6, 2012

(54) HIGH-PRESSURE ARRANGEMENT WITH LOCKING ELEMENT PREVENTING ROTATION OF LOAD BASKET

(75) Inventors: Joakim Brangel, Vasteras (SE); Lennart Svensson, Vasteras (SE)

(73) Assignee: Avure Technologies AB, Västerås (SE)

(21) Appl. No.: 13/576,056

(22) PCT Filed: Feb. 1, 2010
(86) PCT No.: PCT/EP10/51195

§ 371 Date: Jul. 30, 2012

(51) Int. Cl. B30B 13/00; B30B 15/30

(52) U.S. Cl. 100/35; 100/215

(57) ABSTRACT

A high-pressure pressing arrangement includes two coaxial end closures; a high-pressure cylinder including two coaxial end openings, which are closable by the end closures; a frame for resisting outward axial movement of the end closures; a load basket for carrying articles to be treated, wherein the high-pressure cylinder and the frame are arranged transversally movable relative to each other between an operating position and a loading/unloading position; wherein, in the operating position, the end closures are positioned to cover the end apertures and in the loading/unloading position, at least one of the end closures is positioned to uncover at least one end aperture. Further, a first locking element is provided on an end closure and a second locking element is provided on an outward end surface of the load basket, so as to mate with the first element to prevent rotation of the load basket.

### TECHNICAL FIELD

The invention disclosed herein generally relates to high-pressure vessels with removable load baskets, in which articles for treatment are contained. In particular, the invention relates to measures for preventing or limiting rotary motion of load baskets during pressure treatment.

### BACKGROUND

High-pressure vessels are vessels adapted to withstand a pressure difference of at least 1,000 bar, preferably between 3,000 and 8,000 bar. To maximise their mechanical strength, high-pressure vessels commonly have a cylindrical shape. For similar reasons, the cylindrical inside surface is completely smooth and free from cavities and projections.

In certain applications, such as high-pressure food preservation, articles (which may be in the form of piece goods, a liquid or semi-liquid mass) for treatment are introduced into the high-pressure vessel by means of a perforated load basket having substantially the same dimensions as the inside of the vessel. For ease of loading and unloading, such load basket comprises at least one relatively large top aperture, which however means that the content easily can be discharged if the basket is rotated around its longitudinal axis. Owing to the necessary smoothness of the cylindrical inner surface, the load basket may rotate during a treatment cycle, causing articles to fall out upon removal of the basket. Apart from the delays and inconveniences experienced by operators, such incidents may also be harmful to the processed product from a quality assurance aspect. It is believed that the rotation occurs in connection with the pre-filling of the vessel, during which the pressure medium, such as water or some other liquid, is introduced at a relatively high rate in order to keep the cycle time low. A static rotary torque may also arise if the buoyancy on the submerged articles, such as foodstuff enclosed with some ambient air in gastight packages, is not symmetrically distributed in the transversal direction.

It has been attempted to prevent rotation by arranging high-density ballast elements near the intended bottom surface of the load basket, so as to lower its centre of gravity to improve stability. Combining two materials having different compressibility may however lead to harmful internal mechanical stress when the basket is subjected to high pressure. The increase in basket weight also represents an operational disadvantage and may call for machine aid for the insertion and removal of the baskets.

### SUMMARY OF THE INVENTION

An object of the invention is to at least alleviate the above-mentioned problem of undesired rotation of a load basket in a pressure vessel.

Therefore, in a first aspect of the invention, a high-pressure pressing arrangement as set out in claim 1 is provided.

As can be readily understood from the claims, the inventive manner of preventing relative rotary motion, that is, by way of form-locking action between respective locking elements on the load basket and at an end closure of the vessel, suffers to a lesser extent from the disadvantages of available solutions. The invention proposes a solution that does not cause any appreciable weight increase to the load basket. Further, the locking element on the load basket can be manufactured from the same material as the rest of the basket, which avoids harmful local deformation stress.

In other aspects of the invention, there are provided a high-pressure press, a load basket, a conveyor as well as a method of performing high-pressure treatment of articles, as set out in the other independent claims. The dependent claims disclose advantageous embodiments of the invention.

The invention relates to high-pressure equipment capable of pressure treatment at at least 1,000 bar above the atmospheric pressure, and preferably between 3,000 and 8,000 bar. The equipment may be one suitable for high-pressure food preservation, hot or cold isostatic pressing etc.

The invention has been conceived in respect of a high-pressure pressing arrangement comprising a high-pressure vessel made up from a high-pressure cylinder and two coaxial end closures. The pressure vessel is formed by closing end apertures of the cylinder using end closures, which provide a pressure-tight seal against the environment. During operation and when the pressure vessel is pressurized, each end closure will experience an outward axial force, causing them to abut against a common frame which carries both axial forces.

The cylinder is arranged in a movable fashion between an operating position within the frame, in which a pressure vessel may be formed by closing the end closures, and a loading/unloading position, in which the cylinder is removed from the centre of the frame for enabling opening of at least one of the end closures so as to enable access to at least one end aperture. In the loading/unloading position, articles can be loaded into or unloaded from the cylinder by being contained in a load basket which is inserted or removed through an end aperture of the cylinder.

The pressure vessel can be installed vertically or horizontally. In embodiments of the invention having a vertical cylinder, the load basket can be inserted/removed through a top end and/or a bottom end aperture.

Only one or both end closures may be openable for enabling insertion/removal of the load basket.

According to an embodiment of the invention, the cylinder is installed horizontally and both its end closures are openable. This embodiment is advantageous in that load baskets can be inserted at one end and removed at the other end. Thereby a flow through operation is advantageously enabled.

The shape and dimensions of the load basket may be those of the inside of the high-pressure vessel, allowing some tolerance. Thus, already the shape of the basket prevents it from rotating in other directions than around its longitudinal axis. However, the load basket may have any other suitable shape such as for example a cylinder with square or polygonal cross section.

As provided by the invention, rotation of the load basket, preferably around its longitudinal axis, can be prevented by a locking element arranged on an outward (i.e., facing away from the load compartment of the basket) end surface of the basket adapted to engage a corresponding locking element arranged on an inward (i.e., facing the centre of the cylinder and thus the load basket) end surface of an end closure. The engaging of the locking elements takes place upon closure of the pressure vessel, that is, when the end closures are approached axially. The locking elements are form-locking, hence, they comprise at least two bodies adapted to abut against one another in such manner that a useful force (i.e., a force counteracting rotary motion) is transmitted in a direction substantially normal to at least one of the surfaces.

The locking elements can be provided at one or both ends of the load basket for cooperation with complementary locking elements at one or both end closures, respectively.

The locking elements may form pairs of a recess (cavity) and a protrusion (projection), of which the protruding element may be provided on the basket or the end closure. In a preferable embodiment, however, the (first) locking element on the end closure is a recess or cavity, while the (second) locking element on the basket is a protrusion or projection. Thus, the useful length and volume of the pressure vessel are preserved.

For example, the cavity may be a cylindrical, conical or frustum-like depression or hole, with any suitable cross-section shape, or groove. The protrusion may be a pin, rib, dovetail, lip or knob. It may be tapered or straight, and either hollow or solid. Plural locking elements may be provided on one or both sides of a load basket or an end closure.

The end closure can be provided with an inward tip which may have a cylindrical or frustum-like shape. When the end closure is positioned on the cylinder for closing the same, the extends inside the cylinder. A circumferential seal at the tip seals between the cylinder and the end tip of the end closure. In an improvement of this embodiment, the recess is a groove in the inward (that is, facing the middle of the cylinder and thus, the load basket) end surface of the end closure and extending to and opening to the circumferential surface of the tip. This allows the protrusion of the load basket to enter laterally into the groove, and to be removed laterally therefrom. This represents a constructional advantage in a class of pressing arrangement having their high-pressure cylinder arranged so that it is transversally movable (i.e., the cylinder can be moved in at least one radial direction) to or from an operating position in which it is located within the frame and substantially coaxial with the end closures arranged at the frame. The end closures are arranged so that they are longitudinally movable with respect to the frame, and capable of being approached to form a closed pressure vessel together with the cylinder. Because the protrusion on the basket can be inserted laterally—not only frontally—into the groove on an end closure in this embodiment, the necessary stroke length of the end closures decreases. This in turn provides for a corresponding decrease in the length of the frame. Suitably, the shape of the groove corresponds to the restrained motion path of the high-pressure cylinder with respect to the frame and the end closures. In connection with a high-pressure cylinder which is linearly movable to and from its coaxial position, the groove suitably extends linearly in the direction of movement.

In one embodiment, the recess has at least one bevelled top edge, in order to facilitate entry of the protrusion while ensuring a tight fit once the protrusion has entered past the bevelled edge. In another embodiment, the protrusion may be a tapered element to achieve a similar effect. In particular, the protrusion may be a pin, preferably a tapered pin. Further, it is possible to combine, as another advantageous embodiment, a recess having a bevelled edge with a tapered protrusion; the insertion of the load basket into the cylinder thus is a less delicate manoeuvre as far as orientation is concerned, and yet, only a limited amount of play between the protrusion and the recess in their fully assembled condition is necessary.

In an advantageous embodiment, the recess has limited depth in order to limit the additional mechanical stresses in comparison with an end closure having no recess therein. More precisely, the recess on the end closure is provided completely in an inward end region, which is isostatically loaded. If the circumferential surface of the end closure is sealed against the cylindrical inner surface of the pressure cylinder by a circumferential pressure seal, then the isostatically loaded region approximately does not extend further than a plane defined by the inner edge of the seal. Thus, preferably, the recess should not extend deeper from a top surface of the end closure than to the plane containing the top edge of the seal.

In one embodiment, the protrusion at the load basket has variable length (is extensible and/or retractable) in the longitudinal direction of the load basket and outwardly biased, so as to account for isostatic compression of the load basket during a high-pressure treatment of the cycle. This way, although the basket may contract by several percent in length, the protrusion extends and will not slip out of the recess, which could otherwise damage the basket if it decontracts out of its correct mating position. The biasing may be achieved by executing the protrusion in a spring-loaded telescoping fashion. Alternatively, a number of slits in the fastening area of the protrusion may give the protrusion a sufficient resilience in relation to the basket when depressed in the longitudinal direction of the basket.

In one embodiment, a load basket may comprise a further (third) locking element, which is complementary to the (second) locking element used for preventing rotation with respect to the end closure. Hence, a load basket with such further (third) locking element engages with another load basket, when brought together with this coaxially, thereby preventing relative rotation. The provision of such further (third) locking element facilitates insertion of two or more consecutive load baskets into the pressure cylinder, because it is sufficient to ensure that either of the baskets is correctly oriented with respect to the (first) locking elements on the end closure. The use of several load baskets instead of one may be advantageous for high-density loads. A load basket may comprise such further (third) locking means on one side or on both side, so that it is reversible.

In a further advantageous embodiment, there is provided a recess or groove extending over the length of the load basket, to allow aligning upon insertion of the basket into the high-pressure cylinder. More precisely, the high-pressure press comprises an aligning element which cooperates with the recess as the load basket proceeds into the cylinder. Preferably, the recess or groove extends over the full length of the load basket and opens to each end surface. Further preferably, the recess or groove has such dimensions that it additionally serves as a torsional stiffening element. The insertion of the load basket may take place by means of a conveyor or other device for maintaining the basket coaxial with respect to the high-pressure cylinder and/or (partially) supporting the weight of the basket to offload the operator. Conventional conveyors may be fully automatic and fully mechanised, fully mechanised but semi-automatic, partially manually operated, etc. Depending on the orientation of the high-pressure cylinder, the conveyor may be horizontal, vertical or have some other orientation. Most conventional conveyors allow a load basket present thereon to rotate around its longitudinal axis. One or more aligning means that cooperate with a recess on the load basket will immediately ensure that the (first) locking means on the end closure is correctly positioned with respect to the (second) locking means on the load basket, so that the two mate with each other as intended when the end closures are applied.

An aligning means for cooperation with the longitudinal recess on the basket may be a protrusion, in particular a pin or loop, provided on or near an end side of the high-pressure cylinder, extending some distance into an insertion aperture in a direction substantially parallel to the aperture, thereby covering, in an end-side view, some portion of the aperture. Such protrusion may be attached to a conveyor or to some other unit in the pressing arrangement. Thus, the load basket is maintained in the proper orientation as long as it cooperates with the protrusion, that is, with the exception of the short last phase of the insertion operation, when the outer end surface of the load basket has proceeded axially into the segment between the protrusion and the insertion aperture. As an alternative, the aligning means may be a guide rail attached to the conveyor and extending alongside of this. The guide rail does not necessarily extend over the full length of the conveyor, but preferably continues substantially up the plane of the insertion aperture of the cylinder, so that the last, unaligned phase of the insertion operation is as short as possible, thereby minimising the risk of misalignment.

In another embodiment, the load basket does not have a longitudinal recess or has a recess which is not for alignment purposes. Instead, one or more locking elements on an outward end surface of the load basket is used to achieve alignment during insertion, in that a pusher arm has complementary locking elements engaging the locking means when the basket is correctly oriented. Furthermore, the pusher arm may, in a highly automated pressing arrangement, comprise an automatic rotating means for realigning the basket before, during or after the insertion of the load basket into the cylinder.

In another aspect of the invention, there is provided a high-pressure pressing arrangement with automatic realigning. The system includes a frame; a high-pressure cylinder, which is transversally movable with respect to the frame; two movable coaxial end closures capable of forming a high-pressure vessel together with the cylinder when this is coaxial with the end closures; and a load basket suitable for being contained in the high-pressure vessel. Additionally, it includes an orientation sensor, for determining the orientation of the load basket after completion of the high-pressure treatment, and a rotating means for realigning the load basket into its correct orientation, wherein its loading aperture is oriented upwards and there is a reduced risk of articles being discharged upon removal of the basket from the high-pressure cylinder. The orientation sensor may be contactless (optical, ultrasonic, magnetic or the like) or a mechanical probe making contact with holes or protrusions on the load basket. The rotating means may be a robotic arm, preferably a retractable arm provided on a conveyor device.

In yet another aspect of the invention, there is provided an improved load basket, wherein at least one upper load aperture is covered by releasable, slidable or hinged lids preventing articles from falling out of the load basket in a non-upright position.

### BRIEF DESCRIPTION OF THE DRAWINGS

Embodiments of the invention will now be described with reference to the accompanying drawings, on which:

FIG. 1 is a perspective view of a high-pressure pressing arrangement in a loading mode, in accordance with an embodiment of the invention;

FIG. 2 is a perspective view of a load basket according to an embodiment of the invention;

FIG. 3 is a perspective view and a side view of an end closure for a high-pressure press according to an embodiment of the invention; and

FIG. 4 is a side view of the load basket of the kind shown in FIG. 3 when engaging two end closures of the kind shown in FIG. 4.

### DETAILED DESCRIPTION OF EMBODIMENTS

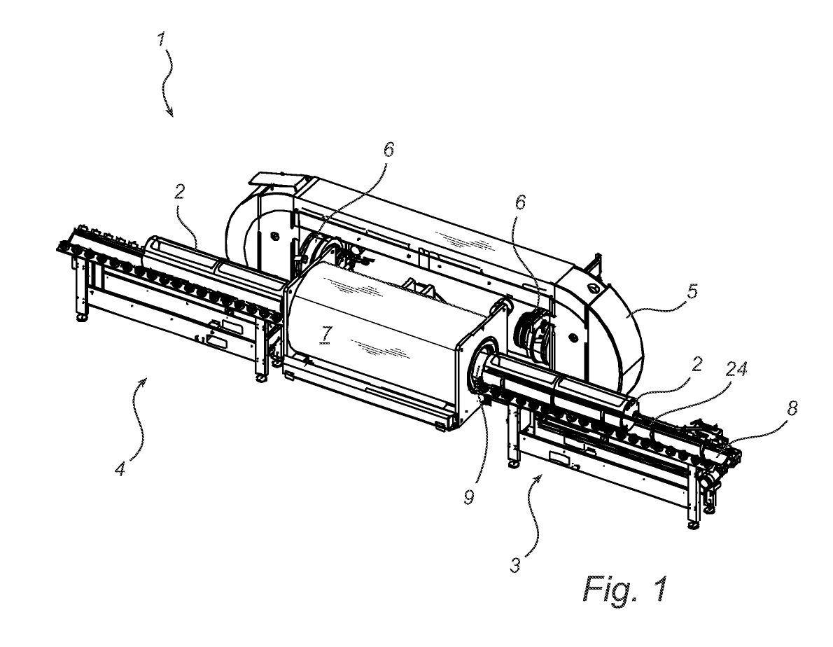

FIG. 1 shows a high-pressure pressing arrangement 1 according to an embodiment of the present invention. The pressing arrangement generally comprises a press, at least one load basket 2, an insertion conveyor 3 and a removal conveyor 4. The press comprises a frame 5, at which two end closures 6a, 6b are arranged linearly movable substantially in the longitudinal symmetry plane of the frame 5. The two end closures 6 are preferably coaxial. At the frame 5, there is further provided a movable high-pressure cylinder 7, which travels between an off-axis loading/unloading position, as shown in FIG. 1, and a coaxial operational position (not shown) within the frame, in which the end closures 6 may approach to form a closed pressure vessel with the cylinder 7. In the disclosed embodiment, the insertion conveyor 3 comprises an elevated horizontal roller bed 8 that ensures correct alignment of the longitudinal axis of the load basket 2 with respect to the cylinder, allowing an operator to push it with a moderate force into a loading aperture 9 of the cylinder 7.

In the exemplary embodiment of the pressing arrangement, a liquid pressure medium is used, preferably water, oil or an emulsion of the two. The problem of undesired rotary motion may also occur in pressing arrangements of a different kind, particularly arrangements for processing gas-filled packages.

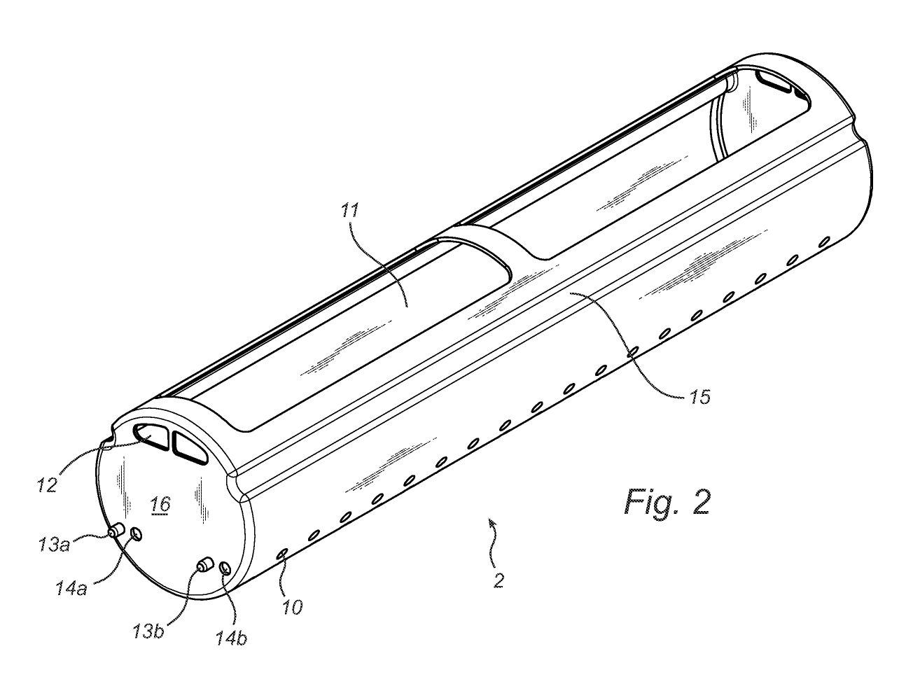

FIG. 2 is a detailed view of the load basket 2. Functionally, the load basket 2 acts as a carrier for articles to be treated in the pressure vessel, thereby expediting loading and unloading of the articles. In an advantageous embodiment, the load basket 2 is manufactured by integral moulding of a polymeric material that is movable at low friction against the inside surface of the cylinder. When suitable, minor protruding details may be welded onto the basket 2 after moulding. The load basket 2 has a shape and dimensions corresponding to the inside of the pressure vessel, that is, a generally cylindrical shape. Pressure medium can be drained from the bottom side of the load basket 2 through one or more drain hole 10. Loading and unloading of articles are effected through a top aperture 11, which is divided into two sub-apertures to achieve an improved mechanical stiffness. Grip holes 12 are provided on the end sides 16 to facilitate handling. On each end side 16, there are provided two tapered pins 13a, 13b and two holes 14a, 14b, each having such diameter and placement that it can receive a pin having the same shape and placement as the adjacent pin 13, of another load basket when this is approached coaxially and with the correct orientation. Each pin 13 engages in a form-locking manner with a corresponding hole 14, so that the two baskets are prevented from relative rotary motion.

In other embodiments, the pins 13 and holes 14 may be replaced by elements having a different geometry, however with a similar form-locking function. For instance, a horizontal locking rib does preferably not extend across the vertical symmetry line of the outward end surface 16, as this would render impossible the provision of an element to mate with this.

The load basket 2 further comprises two longitudinal grooves 15, extending all the way between the end surfaces 16 and opening to these surfaces. Preferably, the grooves 15 are located closely to the top aperture 11 in order to compensate for the lower mechanical stiffness in this region. As will be discussed below, both the pins 13 and grooves 15 will cooperate with elements of the pressing arrangement to ensure that the top aperture 11 is oriented upwardly.

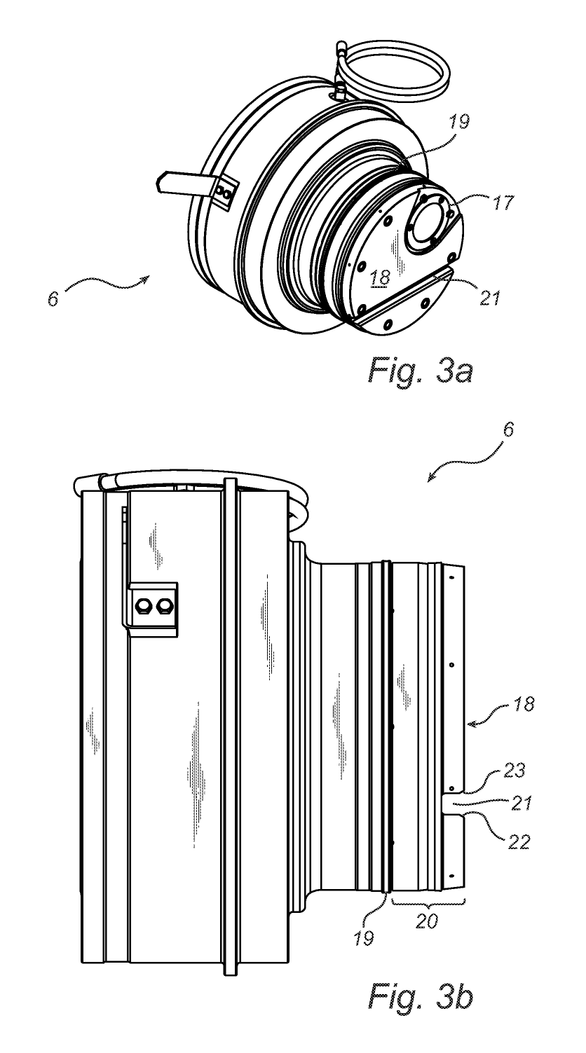

FIG. 3 is a detailed view of an end closure 6, namely an end closure 6 having a valve 17 on its inward end surface 18 for admitting pressure medium during filling. The circumferential surface 20 of the closure 6 is composed of consecutive layers succeeding one another longitudinally. A circumferential pressure seal 19 is provided some distance from the inward end surface 18. Clearly, the portion of the end closure 6 located inside of the seal 19 is isostatically loaded.

In the capacity of locking element, a groove 21 is provided on the end surface 18 of the end closure 6. In this embodiment, the recess opens at both ends to the circumference 20 of the end closure 6. The pin 13 of the load basket 12 enters and leaves the groove 21 at one of its ends or, in embodiments where the cylinder can be moved to both sides of its coaxial position with respect to the frame, at both ends. As can be readily seen in FIG. 3B, the groove 21 does not extend beyond the pressure seal 19, which would otherwise lead to locally inadmissible stress in the closure 6 when subjected to high pressure.

As is also visible particularly in FIG. 3B, the groove 21 has two bevelled edges 22, 23, which guide the pin 13 into the groove 21 when this enters from the end surface 18 in a slightly misaligned position. The guiding ability of the cooperating pin 13 and groove 21 is further enhanced by the tapered shape of the pin 13.

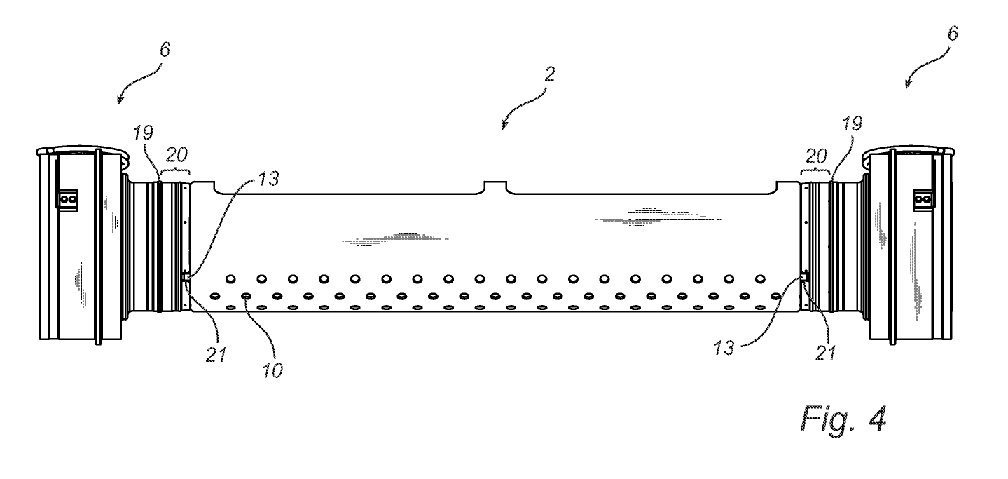

FIG. 4 shows a load basket 2 engaging both end closures 6 in a closed position of the high-pressure cylinder (not shown in FIG. 4). The load basket 2 is efficiently prevented from rotating relative to the end closures 6. It is noteworthy that, with respect to the end closures 6 alone, the basket 2 is movable in the direction of the groove 21. Hence, if for some reason the basket 2 is displaced axially towards either side in the open position of the closures 6, so that the pin 13 engages the groove 21 again, yet it will not prevent the high-pressure cylinder 7 from being moved into its loading/unloading position.

It can be appreciated from FIG. 4 that an isostatic compression of the load basket 2, which contracts it by a few per cent, could cause the load basket 2 to disengage from one or both end closures 6 and make it rotatable. In an advantageous alternative embodiment, the pins 13 are extensible and outwardly biased, so as to compensate for the longitudinal contraction.

The insertion conveyor 3 in the high-pressure pressing arrangement 1 shown in FIG. 1 comprises a guide rail 24 extending longitudinally to the conveyor 3 and—when this is properly aligned—to the cylinder 7. The guide rail 24 restrains the load basket 2 to a correctly aligned orientation, though preserving its linear mobility along the conveyor 3. The removal conveyor 4, if used only for removal of load baskets, does not necessarily comprise a guide rail.

In alternative embodiments, the guide rail of the insertion conveyor 3 may be considerably shortened; the truly necessary part is the segment closest to the aperture 9 of the cylinder 7. In particular, an aligning means may be provided in the form of a pin nearby the plane of the aperture 9 having the same angular position as the guide rail 24 shown in FIG. 1.

Although the invention has been illustrated and described in detail in the drawings and preceding description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A high-pressure pressing arrangement, comprising:
a high-pressure vessel including a high-pressure cylinder and two coaxial end closures, the high-pressure cylinder including two coaxial end openings, which are closable by the end closures;
a frame for resisting outward axial movement of the end closures;
a load basket for carrying articles to be treated in the pressure vessel,
wherein the high-pressure cylinder and the frame are arranged transversally movable relative to each other between an operating position, where the high-pressure cylinder is within the frame, and a loading/unloading position, where the high-pressure cylinder is outside the frame;
wherein, in the operating position, the end closures are positioned to cover the end apertures, so that a closed high-pressure vessel is formed; and
wherein, in the loading/unloading position, at least one of the end closures is positioned to uncover at least one end aperture, so that at least one of insertion and removal of the load basket is enabled;
a first locking element provided on an inward end surface of an end closure; and
a second locking element provided on an outward end surface of the load basket, the second locking element being complementary to said first locking element and being adapted to mate with the first locking element in a form-locking manner so as to prevent rotation of the load basket when the load basket is inserted into the high-pressure cylinder and when the high-pressure cylinder is in the operating position.

2. A high-pressure pressing arrangement according to claim 1, wherein
the first locking element is a recess; and
the second locking element is a protrusion.

3. A high-pressure pressing arrangement according to claim 2,
wherein the end closure, in which said recess is provided, comprises a circumferential pressure seal; and
wherein the recess does not extend beyond an imaginary plane containing a top edge of the pressure seal.

4. A high-pressure pressing arrangement according to claim 2,
wherein the protrusion has variable length in the longitudinal direction of the load basket and outwardly biased.

5. A high-pressure pressing arrangement according to claim 2,
wherein the end closures are arranged at the frame in a longitudinally movable manner;
wherein the end closure comprises a circumferential surface extending in the outward axial direction from the inward end surface; and
wherein the first locking element is a groove provided on the inward end surface and opening to the circumferential surface, thereby allowing lateral entry/exit of the protrusion into/out of the groove during movement of the high-pressure cylinder into/out of the operating position.

6. A high-pressure pressing arrangement according to claim 5,
wherein the cylinder is linearly movable in a first direction with respect to the frame; and
wherein the groove extends in the first direction.

7. A high-pressure pressing arrangement according to claim 2, wherein a top edge of the recess is bevelled.

8. A high-pressure pressing arrangement according to claim 2, wherein the protrusion is a tapered pin.

9. A high-pressure pressing arrangement according to claim 1, further comprising at least one further load basket including a third locking element, the third locking element being complementary to the second locking element and being adapted to mate with said second locking element of another load basket in a form-locking manner, so as to prevent relative rotation.

10. A high-pressure pressing arrangement according to claim 1, further comprising:
a longitudinal recess provided on the load basket; and
an aligning unit provided on a unit in the high-pressure pressing arrangement other than the load basket, adapted to cooperate, upon insertion of the load basket into the high-pressure cylinder, with said longitudinal recess to ensure correct orientation of the load basket.

11. A high-pressure pressing arrangement according to claim 10,
further comprising:
a conveyor for guiding a load basket into the high-pressure cylinder when this is in a loading position,
wherein an aligning unit is affixed to the conveyor in the form of one or more of:
a rail extending longitudinally up to the cylinder; and
a protrusion provided adjacent to the cylinder.

12. A high-pressure press, comprising:
a high-pressure vessel including a high-pressure cylinder and two coaxial end closures, the high-pressure cylinder including two coaxial end openings, which are closable by the end closures;
a frame for resisting outward axial movement of the end closures;
wherein the high-pressure cylinder and the frame are arranged transversally movable relative to each other between an operating position, where the high-pressure cylinder is within the frame, and a loading/unloading position, where the high-pressure cylinder is outside the frame;
wherein, in the operating position, the end closures are positioned to cover the end apertures, so that a closed high-pressure vessel is formed, and
wherein, in the loading/unloading position, at least one of the end closures is positioned to uncover at least one end aperture, so that at least one of insertion and removal of a load basket is enabled; and
a first locking element provided on an inward end surface of an end closure, said first locking element being adapted to mate with a complementary second locking element, which is provided on an outward end surface of the load basket, in a form-locking manner so as to prevent rotation of the load basket when the load basket is inserted into the high-pressure cylinder and when the high-pressure cylinder is in the operating position.

13. A high-pressure press according to claim 12, wherein the first locking element is a recess.

14. A high-pressure press according to claim 13,
wherein the end closure, in which said recess is provided, comprises circumferential pressure seal; and
wherein the recess does not extend beyond an imaginary plane containing a top edge of the pressure seal.

15. A high-pressure press according to claim 13,
wherein the end closures are arranged at the frame in a longitudinally movable manner;
wherein the end closure comprises a circumferential surface extending in the outward axial direction from the inward end surface; and
wherein the first locking element is a groove provided on the inward end surface and opening to the circumferential surface, thereby allowing lateral entry/exit of the protrusion into/out of the groove during movement of the high-pressure cylinder into/out of the operating position.

16. A high-pressure press according to claim 15,
wherein the cylinder is linearly movable in a first direction with respect to the frame; and
wherein the groove extends in the first direction.

17. A high-pressure press according claim 11, wherein a top edge of the recess is bevelled.

18. A load basket for insertion into a high-pressure vessel formed by a high-pressure cylinder and two end closures, the load basket comprising:
a second locking element provided on an outward end surface of the load basket and adapted to mate with a complementary first locking element, which is provided on one of the end closures, in a form-locking manner so as to prevent rotation of the load basket when in the high-pressure vessel.

19. A load basket according to claim 18, wherein said first locking element is a protrusion.

20. A load basket according to claim 19,
wherein the protrusion has variable length in the longitudinal direction of the load basket and outwardly biased.

21. A load basket according to claim 19,
wherein said protrusion is a tapered pin.

22. A load basket according to claim 18, further comprising a third locking element, which is complementary to the second locking element adapted to mate with said second locking element of another load basket in a form-locking manner, so as to prevent relative rotation.

23. A load basket according to claim 18, further comprising a longitudinal recess adapted to cooperate, upon insertion into the high-pressure cylinder, with an aligning means ensuring correct orientation.

24. A conveyor for guiding a load basket into a high-pressure cylinder when this is in a loading position, the conveyor comprising:
an aligning unit adapted to cooperate with a longitudinal recess on the load basket upon insertion into the high-pressure cylinder, the aligning unit being selected from a group consisting of:
a rail extending longitudinally up to the cylinder; and
a protrusion provided adjacent to the cylinder.

25. A method of performing high-pressure treatment of articles, comprising:
loading the articles into a load basket having a longitudinal recess and a locking element;
inserting the load basket into a high-pressure cylinder using a conveyor provided with an aligning unit cooperating with said longitudinal recess for thereby ensuring correct orientation of the load basket;
closing the pressure cylinder by two end closures, at least one of which is provided with another locking element engaging the locking element in a form-locking manner so as to prevent rotation of the load basket;
carrying out high-pressure treatment;
opening the pressure cylinder;
removing the load basket from the high-pressure cylinder; and
unloading the articles.

26. A method according to claim 25, wherein said high-pressure treatment is high-pressure food preservation.
